(19) United States
(12) Patent Application Publication
(10) Pub. No.: US 2024/0335750 A1
(43) Pub. Date: Oct. 10, 2024

(54) PERSONAL PROGRESS CHARMS

(71) Applicant: IGT, Las Vegas, NV (US)

(72) Inventors: Dwayne Nelson, Las Vegas, NV (US); Cameron Filipour, Las Vegas, NV (US); Patrick Danielson, Las Vegas, NV (US)

(21) Appl. No.: 18/131,958

(22) Filed: Apr. 7, 2023

(51) Int. Cl. A63F 13/537; A63F 13/45

(52) U.S. Cl. CPC A63F 13/537; A63F 13/45

(57) ABSTRACT

Embodiments are directed to providing persistent indicators of personal progress in a gaming environment. According to one embodiment, providing personal progress indicators can comprise receiving game interaction information related to an electronic game executed on a gaming system and indicating an action of a player of or occurrence of an event in the electronic game. A determination can be made as to whether the game interaction information is indicative of a change in personal progress for the player. In response to determining the game interaction information is indicative of a change in personal process for the player, an electronic record associated with the player of the electronic game can be updated to indicate the change in the personal progress for the player and an indication of the change in the personal progress for the player of the electronic game can be provided to the gaming system.

### BACKGROUND

The present disclosure is generally directed to increasing player engagement in a gaming environment and, in particular, toward providing persistent indicators of personal progress.

Operators of gaming systems such as Electronic Gaming Systems (EGMs), Video Lottery Terminals (VLTs), sports betting terminals, and gaming venues in which they are installed benefit in terms of increased revenue when player engagement is increased. Player engagement can be increased by building excitement as well as a sense persistence across games. Hence there is a need in the art for increasing engagement of players by building excitement and a sense of persistence.

### BRIEF SUMMARY

Embodiments of the present disclosure are directed to providing persistent indicators of personal progress in a gaming environment. According to one embodiment, a method for providing personal progress indicators in a gaming environment can comprise receiving game interaction information related to an electronic game executed on a gaming system and indicating an action of a player of or occurrence of an event in the electronic game. A determination can be made as to whether the game interaction information is indicative of a change in personal progress for the player in the electronic game. In response to determining the game interaction information is indicative of a change in personal process for the player in the electronic game, an electronic record associated with the player of the electronic game can be updated to indicate the change in the personal progress for the player of the electronic game, and an indication of the change in the personal progress for the player of the electronic game can be provided to the gaming system.

In some cases, the indication of the change in the personal progress for the player of the electronic game can be based on a selection of an initial progress indicator received from the player of the electronic game. In such cases, the indication of the change provided to the gaming system can comprise a visible change to the initial progress indicator. In other cases, the indication of the change in the personal progress for the player of the electronic game can be based on a selection of an initial progress indicator received from the gaming system. In such cases, the indication of the change provided to the gaming system comprises a change to the initial progress indicator.

Determining whether the game interaction information is indicative of a change in personal progress for a player of the electronic game can be further based on one or more pre-defined criteria for activity occurring in the electronic game. In such cases, updating the electronic record associated with the player of the electronic game to indicate the change in the personal progress for the player of the electronic game can comprise updating the electronic record to indicate an improvement in the personal progress for the player of the electronic game when the game interaction information meets or exceeds one or more of the pre-defined criteria for activity occurring in the electronic game. Updating the electronic record associated with the player of the electronic game to indicate the change in the personal progress for the player of the electronic game can additionally, or alternatively, comprise updating the electronic record to indicate a decline in the personal progress for the player of the electronic game when the game interaction information does not meet one or more of the pre-defined criteria for activity occurring in the electronic game. In some cases, the electronic record can be updated to indicate a decline in the personal progress for the player of the electronic game if new game interaction information is not received from the gaming system within a predetermined period of time.

According to another embodiment, a gaming system can comprise a display device, a processor coupled with the display device, and a memory coupled with and readable by the processor. The memory can store therein a set of instructions which, when executed by the processor, causes the processor to store an indicator of personal progress for a player of an electronic game. In some cases, the instructions can further cause the processor to receive the indicator of personal progress for the player of the electronic game from a host system of a gaming venue. In other cases, the instructions can further cause the processor to select the indicator of personal progress for the player of the electronic game from a plurality of available indicators of personal progress.

The instructions can further cause the processor to detect a presence of the player of the electronic game proximate to the gaming system and, in response to detecting the player of the electronic game, provide, through the display device, a representation of the indicator of personal progress for the player of the electronic game. In some cases, the gaming system can further comprise a wireless communications interface. In such cases, detecting the player of the electronic game can comprise detecting a mobile device of the player of the electronic game in proximity to the gaming system through the wireless communications interface. Additionally, or alternatively, detecting the player of the electronic game can comprise identifying the player of the electronic game during initiation of the electronic game. Providing, through the display device, the representation of the indicator of personal progress for the player of the electronic game can comprise displaying an animation of the indicator of personal progress for the player of the electronic game.

The instructions can further cause the processor to conduct the electronic game with the player of the electronic game, monitor game interaction information indicating an action of a player of or occurrence of an event in the electronic game while conducting the electronic game, determine whether to update personal progress for the player of the electronic game based on the game interaction information and one or more pre-defined criteria, and in response to determining to update the personal progress for the player of the electronic game, update the stored indicator of personal progress for a player of an electronic game and the representation of the indicator of personal progress for a player of an electronic game provided through the display device based on the game interaction information.

According to another embodiment, a mobile device can comprise a wireless communications interface, a display device, a processor coupled with the wireless communications interface and the display device, and a memory coupled with and readable by the processor. The memory can store therein a set of instructions which, when executed by the processor, causes the processor to receive, via the wireless communications interface, an indicator of personal progress in an electronic game for a user of the mobile device, store, in the memory, the indicator of the personal progress in the electronic game for the user of the mobile device and present, through the display device, the indicator of the personal progress in the electronic game for the user of the mobile device. The indicator of the personal progress in the electronic game for the user of the mobile device can comprise an animated graphic, for example.

In some cases, receiving the indicator of personal progress in the electronic game for the user of the mobile device comprises receiving the indicator, through the wireless communication interface, from a host system of a gaming venue. In other cases, receiving the indicator of personal progress in the electronic game for the user of the mobile device can comprises receiving the indicator, through the wireless communication interface, from a gaming system on which the electronic game is executed. In yet other cases, receiving the indicator of personal progress in the electronic game for the user of the mobile device can comprise receiving a selection of one of a plurality of available indicators from a user of the mobile device.

The instructions further cause the processor to receive, via the wireless communications interface, an updated indicator of personal progress in the electronic game for the user of the mobile device. The updated indicator of personal progress can be based on execution of the electronic game. The instructions can cause the processor to store, in the memory, the updated indicator of the personal progress in the electronic game for the user of the mobile device and present, through the display device, the updated indicator of the personal progress in the electronic game for the user of the mobile device.

Additional features and advantages are described herein and will be apparent from the following Description and the figures.

### BRIEF DESCRIPTION OF THE SEVERAL VIEWS OF THE DRAWINGS

FIG. 1 is a block diagram illustrating elements of an exemplary gaming environment for providing persistent indicators of personal progress according to one embodiment of the present disclosure.

FIG. 2 is a block diagram illustrating additional details of components of an exemplary host system according to one embodiment of the present disclosure.

FIG. 3 is a block diagram illustrating additional details of components of an exemplary gaming system according to one embodiment of the present disclosure.

FIG. 4 is a block diagram illustrating additional details of components of an exemplary mobile device according to one embodiment of the present disclosure.

FIG. 5 is a flowchart illustrating an exemplary process for providing persistent indicators of personal progress in a gaming environment according to one embodiment of the present disclosure.

FIG. 6 is a flowchart illustrating an exemplary process for providing persistent indicators of personal progress in a gaming environment according to another embodiment of the present disclosure.

FIG. 7 is a flowchart illustrating an exemplary process for providing persistent indicators of personal progress in a gaming environment according to yet another embodiment of the present disclosure.

### DETAILED DESCRIPTION

Embodiments of the present disclosure are directed to providing persistent indicators of personal progress. Perceived persistence can be one of the most powerful mechanics in a gaming environment that most strongly correlates with game success. Perceived persistence can give the player a satisfying feeling of progress and add an extra moment of excitement and potential to wagers which increases player engagement and in turn increasing potential revenue for the operator of a gaming environment in which the game is installed. Visual representations of persistence, such as pots of gold, banks, fireworks, etc. can be extremely powerful at generating positive superstition. The present disclosure is directed to providing personal progress indicators such as charms. These indicators can be provided in the form of lucky charms with persisted state and can grow or change over time indicating player progress and causing player engagement and excitement. For example, players might select a Pot of Gold charm or indicator. This charm can appear to grow over time with player input and activity giving the player interaction with the charm and the sense of control over the luck provided. When the indicators are used in or near a gaming system, the gaming system or player's mobile can present the indicators.

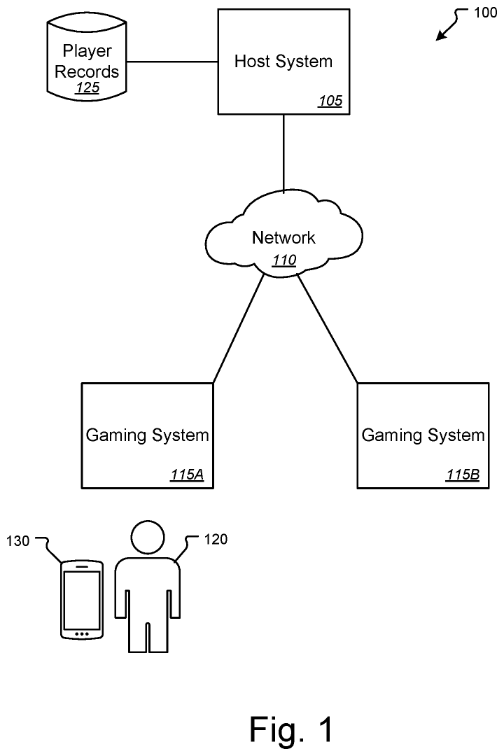

FIG. 1 is a block diagram illustrating elements of an exemplary gaming environment for providing persistent indicators of personal progress according to one embodiment of the present disclosure. As illustrated in this example, the environment 100 can comprise a host system 105 such as any one or more servers and or other computer systems coupled with a communications network 110. The communications network 110 can comprise any one or more wired and/or wireless, local area and/or wide area networks as known in the art. Also coupled with the network 110 can be any number of gaming systems 115A and 115B. The gaming systems 115A and 115B can each execute an electronic game including, but not limited to video slots, video poker, a video table game, any of a variety of well-known casino games.

According to embodiments described herein, a player 120 of a gaming system 115A can be provided with a persistent indicator of personal progress in the electronic game provided by the gaming system 115A. The progress indicators can be lucky symbols or animations chosen by or given to a player 120. They can be associated with the player account or player mobile device. Progress indicators can also be associated with a gaming machine 115A, lottery terminal, sports wagering terminal, game theme, game features, etc. The progress indicators are described herein as images, but it should be appreciated that the progress indicators can animate, flow, make sounds and interact with human input, game events, etc.

For example, the progress indicator can grow in size or change appearance over time. This can be considered the progress indicator's level. The level could be expressed as a number from 1 to 10, as just an example, where level 1 is, for example an empty pot of gold and level 10 is the pot overflowing with gold coins. In general, as a progress indicators level increases, its visual representation can change and appear better or luckier than the previous level. This can be a powerful effect that helps increase player engagement. The progress indicator can also have a tier. When the progress indicator reaches its maximum level, it might change to the next tier and start at level 1 of that tier.

According to one embodiment, the player 120 can be allowed to pick one or more lucky progress indicators. The number of progress indicators the player 120 may be allowed to pick can be configured on the host system 105 and/or gaming system 115A or tied to various mechanisms. The number of progress indicators the player 120 can choose can be determined by any one or more of a system configuration by the operator, player choice, player loyalty club level, e.g., bronze level players get 1 progress indicator while gold level players get 3 progress indicators, a purchase using money, a purchase using player loyalty points, a purchase using some virtual currency, a random offering, a weighted offering, and/or others. According to one embodiment, some progress indicators can be more common or rare than others. These may be made available based on player activity such as a bonus that wins a progress indicator or a total amount the player 120 has wagered over time. Likewise, the progress indicators that the player 120 is able to pick can also be tied to the above list, such that a Pot of Gold progress indicator is pickable by a gold level player, but not by a bronze level player.

According to one embodiment, progress indicators may be selected by the player 120 through an application executing on a mobile device 130. In this case, the application can allow the player 120 to choose one or more progress indicators, based on the configuration and rules applied. The application can also show the current player progress indicator(s). In some cases, the application might show the player 120 the next tier of the progress indicator. The progress indicators in the player mobile application might animate or make sounds when touched, randomly or when viewed by the player. In another embodiment the progress indicators can be picked by the player 120 through the gaming system 115A.

In one embodiment the player 120 can be offered a game or method on the mobile device 130 to increase the progress indicator. This offer could come periodically or be offered continuously. The game that increases the level could be a casino game such as poker, slot, king, etc. The game could be a toss of a pair of dice, the spinning of a wheel, a skill game, or a social game.

In one embodiment, the progress indicator tier and level can be stored on the mobile device 130. In another embodiment, the progress indicator tier and level can be stored on the host system 105 in a set of player records 125. In this embodiment, the game played can be hosted on the host system such that the logic for progress indicator growth is executed on the host system. One example implementation would be a web based game on the mobile device 130 where the host system 105 has the logic.

In one embodiment the player 120 can play the game to grow the progress indicator on the gaming system 115A. The progress indicators can grow over time from playing electronic games on this gaming system 115A or other gaming systems 115B. Game play, such as money wagered, money won, events triggered, or bonuses triggered increase the progress indicator level and/or tier over time. In such cases, the gaming system 115A can communicate with the host system 105. As the player 120 plays the games, the wager, win, and loss can be sent to the host system 105 which can record the activity in the player's records 125. When a certain threshold of activity happens, such as after wagering $1,000, the host system 105 can trigger the progress indicator increase. This action could automatically increase a progress indicator or trigger the mobile device 130 to allow the player to choose a progress indicator to increase. The increase action might allow the player to play a game to increase the progress indicator level as previously described. The activity thresholds that trigger the progress indicator increase can include, but are not limited to, winning a certain amount such as winner $1,000, wagering a certain amount over a certain period of time, winning a certain amount over a period of time, triggering a game feature such as a bonus or reel combination, a win or loss streak, winning a system bonus, etc.

According to one embodiment, the progress indicator might lose level or tier over time if not interacted with or if game activity does not maintain it. This would encourage players to frequently use or interact with their progress indicators. These parameters can be stored by the host system 105 along with the player records 125. In one embodiment, the progress indicators can expire after a certain amount of time such as after one month. In one embodiment, if the progress indicators level decreases to the lowest level, it can be removed.

In one embodiment, the host system 105 can randomly assign one or more progress indicators to one or more gaming system 115A and/or 115B. For example, the host system 105 might assign a heart progress indicator to one gaming system 115A. In another example, the host system 105 might assign a heart chart to the game theme “Wheel of Fortune” on another gaming system 115B. The assignment could be tied to one or more of a physical terminal, a bank of terminals, a location in a property, such as “at the bar”, a specific game theme, such as Wheel of Fortune, a game type such as poker, slot, keno, bingo, etc., a particular cabinet model type, a particular game attribute such as games with bonuses or games with cards, a particular configuration such as denomination or wager amount.

For example, the host system 105 can assign a heart progress indicator to a gaming system 115A. In one embodiment the host system 105 can notify the gaming system 115A of the assignment. The host system 105 can record which progress indicators are assigned to which gaming systems. In another embodiment the host system 105 can pick the progress indicator and assigns it to the gaming system 115A but not notify the gaming system 115A. The player may not be aware of this assignment directly. In one embodiment, when the player's mobile device 130 is located near the gaming system 115A, the mobile device 130 and progress indicator can respond. The response can be one or more of the phone vibrates, the phone makes a sound, the progress indicator animates, text is displayed such as “You're getting close,” etc. The proximity to the gaming system 115A can be detected by the mobile device 130 being in communication with the gaming system 115A using Bluetooth. In another embodiment the proximity to the gaming system 115A can be determined by a beacon such as a Bluetooth beacon in communication with the host system 105. In other embodiments the proximity can be determined by wireless triangulation or video cameras.

In one embodiment, a gaming system 115B near a target gaming system 115A can animated to indicate the player 120 is close to the target gaming system 115A. For example, the casino could use a beacon at a bank of machines. The gaming system 115A or host system 105 can then detect when the player 120 is near the bank so all the machines in the bank could respond. In one embodiment a player 120 with a heart progress indicator in the mobile device 130 can go to the target gaming system 115A that was assigned the heart chart. The gaming system 115A can respond to the player 120 by showing the same, or similar, heart progress indicator on the screen for the player 120 to see. Additionally, or alternatively, the gaming system 115A can respond by playing a sound, playing an animation, using a light pattern, switching game themes, etc.

In one embodiment the progress indicators can be assigned when the player 120 starts playing, such as when money is inserted into the gaming system 115A, or the player tracking card is inserted into the gaming system 115A. In another embodiment the progress indicator can be assigned randomly over time to the gaming system 115A. In another embodiment progress indicators can be assigned when certain event happens such as coin in, a bonus trigger, a particular win such as a bonus, or a large win. In one embodiment the gaming system 115A itself can choose its own progress indicator without the host system 105. This can be done randomly or in response to a player action, game event, or player win.

In one embodiment, the gaming system 115A display can change based on one or more of the player progress indicators. For example, the gaming system 115A credit meter might periodically pulsate when the player progress indicator is present. In one embodiment the player 120 can place their progress indicators on the gaming system 115A screen. The player 120 might place their progress indicator(s) near the credit meter, win meter, a slot reel, etc. The triggering of the progress indicator gaming system 115A progress indicator display event could be one or more of a random event, a particular get event such as a win category, card, reel stop, bonus, etc., a certain win amount, a certain number in the win or credit meter, e.g., the number “7” in the win of 700 might trigger, the position of the player progress indicator on the screen. The progress indicator display method could be one or more of a sound, an image, an animation or movie, the alternate display state of a game element, a change in slot reel, a change in credit or win meter, a change in the background image, a change in slot symbols, an animation or sound associated with the progress indicator itself, a sound, animation or vibration of the player mobile device, etc.

In one embodiment, progress indicators may interact with each other. For example, a unicorn progress indicator might interact with a rainbow progress indicator. The interaction might depend on one or more of relative positions of the progress indicators, absolute positions of the progress indicators, e.g., at least one progress indicator on the slot reel, a progress indicator level or tier, a progress indicator type, certain progress indicators interact more than others, a random event, a game event, a system event, etc. The interaction between the progress indicators could be a visual change in one or more of the progress indicators, a sound played for one or more of the progress indicators, a combination of one or more of the progress indicators into a new progress indicator. For the combination embodiment, the player might place Pot of Gold, Rainbow, and Clover progress indicators on the screen or choose them through the mobile device 130. The Pot of Gold and Rainbow progress indicators could combine into a new, and better, progress indicator that is the Pot of Gold at the End of the Rainbow progress indicator. When they combine the new progress indicator level could start at the lowest level or be assigned a level based on some parameters (random, game event, progress indicator interaction, etc.).

Embodiments described herein can also work with Augmented Reality (AR) and Virtual Reality (VR) applications. In one embodiment, the player progress indicators can interact with the gaming system 115A and the AR system applies animations or display events on the gaming system 115A or the casino environment. For example, if the player 120 approaches and gaming system 115A the player might see the gaming system 115A flash or catch fire in the display their AR headset (not shown here). This version of the present invention basically expands on the gaming system 115A progress indicator events and expands them to include the gaming system 115A cabinet and casino using AR and VR technology. In one embodiment, the players AR headset can show one or more of their selected progress indicators on the casino carpet, thus leading them to a “lucky” gaming system 115A. The AR or VR system could apply the progress indicator interaction to the gaming system 115A cabinet, around the gaming system 115A cabinet, the floor, hallways, ceiling or any real or virtual object in the environment.

According to one embodiment, the progress indicators could be related to sports teams or sports themes. The player 120 might be able to pick a team, an athlete or sport for the progress indicator. If the player picked a team the progress indicator could grow and represent different years of the team, focusing on better and better years for that team. Likewise, if the player picked an athlete, the athlete progress indicator could grow to represent the player from college season to modern day professional MVP. The athlete could change visibility to look faster, better, stronger or more proficient at sports. The athlete could be shown as an image of the player trading card with the increase in level of the progress indicator corresponding to more and more valuable trading cards for that athlete. In one embodiment, the tiers of an NFL themed progress indicator could be tied to the ranking of NFL teams such that the when the progress indicators grows, it changes to a higher ranked NFL team.

In one embodiment the host system 105 or mobile device 130 can track how lucky a progress indicator is and record the events associated with the progress indicator. In some cases, the mobile device 130 could show that a progress indicator is the luckiest one the player has in the mobile application. The mobile device 130 could show an image, text, date, time or videos of lucky events. For example, the player 120 may select a rainbow lucky progress indicator either in the mobile device 130 or places it on the screen of a gaming system 115A. During that play session, if the player 120 wins a royal flush, the mobile device or host system 105 can record that the royal flush, along with its time, amount and other parameters, with the rainbow progress indicator. When the player 120 sees the rainbow progress indicator in the mobile device 130 or gaming system 115A the host system might show last large win, biggest win, total amount won with the progress indicator, number of wins, losses, win percentage or return to player for the progress indicator, total number of hits of a category, such as total flushes or straights, total number, or monetary amount, of bonus triggers, total number, or monetary amount, of system triggers, etc. The mobile device 130 or gaming system 115A might rank the progress indicators by any of these parameters. The mobile device 130 or gaming system 115A might apply these values per game type (poker, keno, etc.), or game theme. For example, for the game “Wheel of Fortune” the rainbow progress indicator has a total win of $1,200 and for the game “Lucky Larry” the total win is $1,600.

According to one embodiment, players may use their mobile device 130 to share, sell or trade progress indicators. This could be person to person or the mobile device 130 might allow for a marketplace to buy, sell and trade progress indicators.

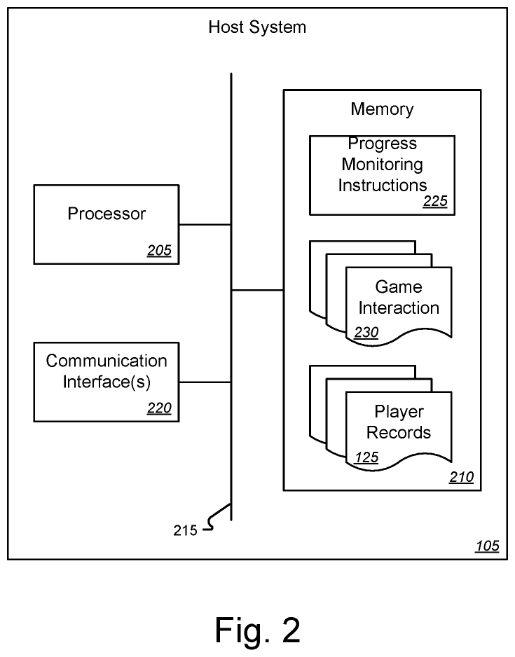

FIG. 2 is a block diagram illustrating additional details of components of an exemplary host system according to one embodiment of the present disclosure. As illustrated in this example, the host system 105 can comprise a processor 205. The processor 205 may correspond to one or many computer processing devices. For instance, the processor 205 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 205 may be provided as a microprocessor, Central Processing Unit (CPU), or plurality of microprocessors that are configured to execute the instructions sets stored in a memory 210. Upon executing the instruction sets stored in memory 210, the processor 205 enables various functions of the host system 105 as described herein.

The memory 210 can be coupled with and readable by the processor 205 via a communications bus 215. The memory 210 may include any type of computer memory device or collection of computer memory devices. Non-limiting examples of memory 210 include Random Access Memory (RAM), Read Only Memory (ROM), flash memory, Electronically-Erasable Programmable ROM (EEPROM), Dynamic RAM (DRAM), etc. The memory 210 may be configured to store the instruction sets depicted in addition to temporarily storing data for the processor 205 to execute various types of routines or functions.

The processor 205 can also be coupled with one or more communications interfaces 220. The communication interfaces 220 can comprise, for example, Ethernet, Bluetooth, WiFi, or other type of wired or wireless communications interfaces.

The memory 210 can store therein a set of progress monitoring instructions 225 which, when executed by the processor 205, causes the processor 205 to define an initial progress indicator for a player 120. In some cases, the initial progress indicator can be defined based on a selection of an initial indicator received from the player 120 of the electronic game. In other cases, the initial progress indicator can be defined based on a selection of an initial indicator received from a gaming system 115.

The progress monitoring instructions 225 can further cause the processor to determine whether game interaction information related to an electronic game executed on a gaming system 115 is available from the gaming system 115. Such game interaction information can indicate an action of a player 120 of or occurrence of an event in the electronic game. In response to determining that game interaction information is available, the progress monitoring instructions 225 can cause the process to receive the game interaction information 230 and determine whether the game interaction information 230 is indicative of a change in personal progress for the player 120 in the electronic game. Determining whether the game interaction information 230 is indicative of a change in personal progress for a player 120 of the electronic game can be based on one or more pre-defined criteria for activity occurring in the electronic game as described above.

In response to determining the game interaction information 230 is indicative of a change in personal process for the player 120 in the electronic game, the progress monitoring instructions 225 can cause the processor 205 to update an electronic record 235 associated with the player 120 of the electronic game to indicate the change in the personal progress for the player 120 of the electronic game. Updating the electronic record associated with the player 120 of the electronic game to indicate the change in the personal progress for the player 120 of the electronic game can comprise updating the electronic record to indicate an improvement in the personal progress for the player 120 of the electronic game when the game interaction information meets or exceeds one or more of the pre-defined criteria for activity occurring in the electronic game. Similarly, updating the electronic record associated with the player 120 of the electronic game to indicate the change in the personal progress for the player 120 of the electronic game can comprise updating the electronic record to indicate a decline in the personal progress for the player 120 of the electronic game when the game interaction information does not meet one or more of the pre-defined criteria for activity occurring in the electronic game. An indication of the change in the personal progress for the player 120 of the electronic game can then be provided to the gaming system 115.

In response to determining that game interaction information is available, the progress monitoring instructions 225 can cause the processor 205 to determine whether any game interaction information for the player 120 has been received during a predetermined time period. In response to determining this predetermined time period has elapsed without receiving new game interaction information, the progress monitoring instructions 225 can cause the processor 205 to update the electronic record to indicate a decline in the personal progress for the player 120 of the electronic game and provide an indication of the change in the personal progress for the player 120 of the electronic game to the gaming system 115.

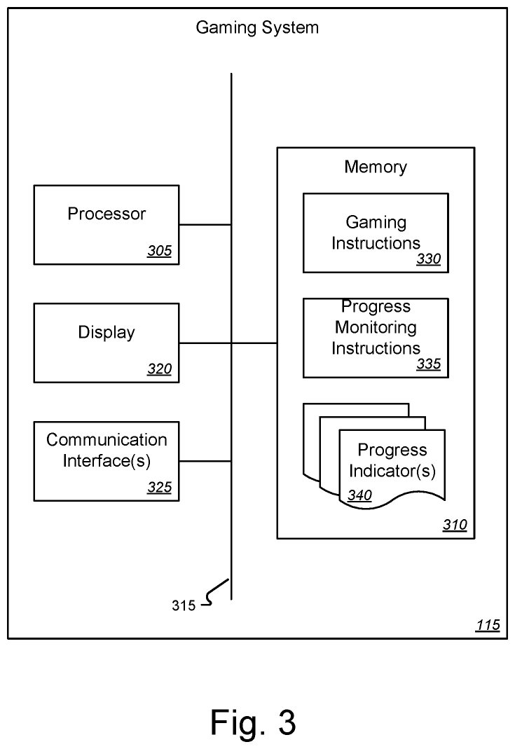

FIG. 3 is a block diagram illustrating additional details of components of an exemplary gaming system according to one embodiment of the present disclosure. As illustrated in this example, the gaming system 115 can comprise a processor 305 such as any of the various types of processors described above. A memory 310 can be coupled with and readable by the processor 305 via a communications bus 315. The memory 310 can comprise any one or more of the different types of volatile and/or non-volatile memories described above. The processor 305 can also be coupled with a display device 320 and one or more communications interfaces 325. The display device 320 can comprise, for example, a Liquid Crystal Display (LCD), Light Emitting Diode (LED), Organic Light Emitting Diode (OLED), or other type of display. The communication interfaces 325 can comprise, for example, Ethernet, Bluetooth, WiFi, or other type of wired or wireless communications interfaces.

The memory 310 can store therein a set of gaming instructions 330 which, when executed by the processor 305, causes the processor 305 to conduct an electronic game with a player 120. The electronic game can be any of a variety of well-known casino games including, but not limited to video slots, video poker, a video table game, etc.

The memory 310 can also store therein a set of progress monitoring instructions 305 which, when executed by the processor 305, cause the processor to define and store an initial progress indicator 340 for a player 120. In some cases, defining an initial progress indicator can comprise receiving a selection of the from a host system 105 of a gaming venue. In other cases, defining an initial progress indicator can comprise receiving from the player 120 a selection of the indicator from a plurality of available indicators of personal progress.

The set of progress monitoring instructions 305 can further cause the processor 305 to detect a presence of the player 120 of the electronic game proximate to the gaming system 115. For example, the communication interfaces 325 of the gaming system 115 can include a wireless communications interface and detecting the player 120 of the electronic game can comprise detecting a mobile device 130 of the player 120 of the electronic game in proximity to the gaming system 115 through the wireless communications interface. In another example, detecting the player 120 of the electronic game can comprise identifying the player 120 of the electronic game during initiation of the electronic game, e.g., during a card-in process.

In response to detecting the player 120 of the electronic game, the set of progress monitoring instructions 305 can cause the processor 305 to provide a representation of the indicator of personal progress for the player 120 of the electronic game through the display device 320 of the gaming system 115. In some cases, providing the representation of the indicator of personal progress for the player 120 of the electronic game can comprise displaying an animation of the indicator of personal progress for the player 120 of the electronic game.

The gaming instructions 330 can cause the processor to conduct the electronic game with the player 120 while the set of progress monitoring instructions 305 can cause the processor to monitor game interaction information indicating an action of a player 120 of or occurrence of an event in the electronic game. The set of progress monitoring instructions 305 can further cause the processor 305 to determine whether to update personal progress for the player 120 of the electronic game based on the game interaction information and one or more pre-defined criteria. In response to determining to update the personal progress for the player 120 of the electronic game, the set of progress monitoring instructions 305 can cause the processor 305 to update the stored indicator of personal progress 340 for a player 120 of an electronic game and the representation of the indicator of personal progress for a player 120 of an electronic game provided through the display device 320 based on the game interaction information.

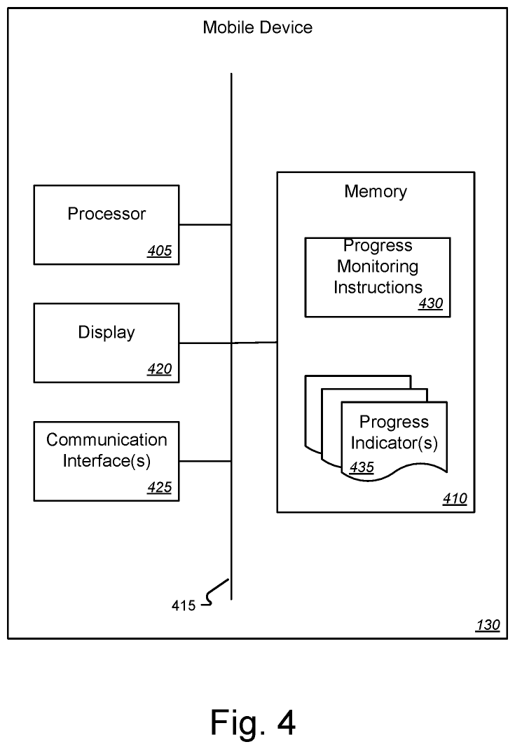

FIG. 4 is a block diagram illustrating additional details of components of an exemplary mobile device according to one embodiment of the present disclosure. As illustrated in this example, the mobile device 130 can comprise a processor 405 such as any of the various types of processors described above. A memory 410 can be coupled with and readable by the processor 405 via a communications bus 415. The memory 410 can comprise any one or more of the different types of volatile and/or non-volatile memories described above. The processor 405 can also be coupled with a display device 420 and one or more communications interfaces 425. The display device 420 can comprise, for example, a Liquid Crystal Display (LCD), Light Emitting Diode (LED), Organic Light Emitting Diode (OLED), or other type of display. The communication interfaces 425 can comprise, for example, Ethernet, Bluetooth, WiFi, or other type of wired or wireless communications interfaces.

The memory 410 can store therein a set of progress monitoring instructions 430 which, when executed by the processor 405, causes the processor 405 to receive through the communication interfaces 425 an indicator of personal progress in an electronic game for a user of the mobile device 130, store the indicator 435 of the personal progress in the electronic game for the user of the mobile device 130, and present the indicator of the personal progress in the electronic game for the user of the mobile device 130 through the display device 420. For example, this initial indicator can be received when a player 120 first registers for personal progress indicators, initiates a game, enters a gaming venue, etc. Receiving the indicator 435 of personal progress in the electronic game for the user of the mobile device 130 can comprise receiving the indicator from a host system 105 of a gaming venue, from a gaming system 115 on which the electronic game is executed, or receiving a selection of one of a plurality of available indicators from a user of the mobile device 130. The indicator 435 of the personal progress in the electronic game for the user of the mobile device 130 can comprise, for example, an animated graphic. As the player 120 plays an electronic game or otherwise interacts with the game and as determinations of progress are made by the gaming system 115 or host system 105 of the gaming venue, the set of progress monitoring instructions 430 can cause the processor 405 to receive an updated indicator of personal progress in the electronic game for the user of the mobile device 130 and based on execution of the electronic game, store the updated indicator 435 of the personal progress in the electronic game for the user of the mobile device 130, and present the updated indicator 435 through the display 420 of the mobile device 130.

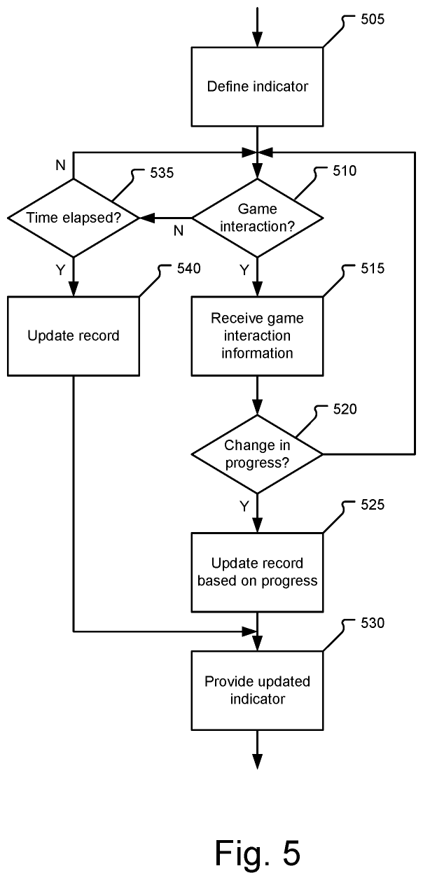

FIG. 5 is a flowchart illustrating an exemplary process for providing persistent indicators of personal progress in a gaming environment according to one embodiment of the present disclosure. As illustrated in this example, the process can begin with defining 505 an initial progress indicator for a player 120. In some cases, the initial progress indicator can be defined 505 based on a selection of an initial indicator received from the player 120 of the electronic game. In other cases, the initial progress indicator can be defined 505 based on a selection of an initial indicator received from a gaming system 115.

A determination 510 can be made as to whether game interaction information related to an electronic game executed on a gaming system 115 is available from the gaming system 115. Such game interaction information can indicate an action of a player 120 of or occurrence of an event in the electronic game. In response to determining 510 that game interaction information is available, the game interaction information can be received 515 and a determination 520 can be made as to whether the game interaction information is indicative of a change in personal progress for the player 120 in the electronic game. Determining 520 whether the game interaction information is indicative of a change in personal progress for a player 120 of the electronic game can be based on one or more pre-defined criteria for activity occurring in the electronic game as described above.

In response to determining 520 the game interaction information is indicative of a change in personal process for the player 120 in the electronic game, an electronic record associated with the player 120 of the electronic game can be updated 525 to indicate the change in the personal progress for the player 120 of the electronic game. Updating 525 the electronic record associated with the player 120 of the electronic game to indicate the change in the personal progress for the player 120 of the electronic game can comprise updating the electronic record to indicate an improvement in the personal progress for the player 120 of the electronic game when the game interaction information meets or exceeds one or more of the pre-defined criteria for activity occurring in the electronic game. Similarly, updating 525 the electronic record associated with the player 120 of the electronic game to indicate the change in the personal progress for the player 120 of the electronic game can comprise updating the electronic record to indicate a decline in the personal progress for the player 120 of the electronic game when the game interaction information does not meet one or more of the pre-defined criteria for activity occurring in the electronic game. An indication of the change in the personal progress for the player 120 of the electronic game can then be provided 530 to the gaming system 115.

In response to determining 510 that game interaction information is available, a further determination 535 can be made as to whether any game interaction information for the player 120 has been received during a predetermined time period. In response to determining 535 this predetermined time period has elapsed without receiving new game interaction information, the electronic record can be updated to indicate a decline in the personal progress for the player 120 of the electronic game and an indication of the change in the personal progress for the player 120 of the electronic game can then be provided 530 to the gaming system 115.

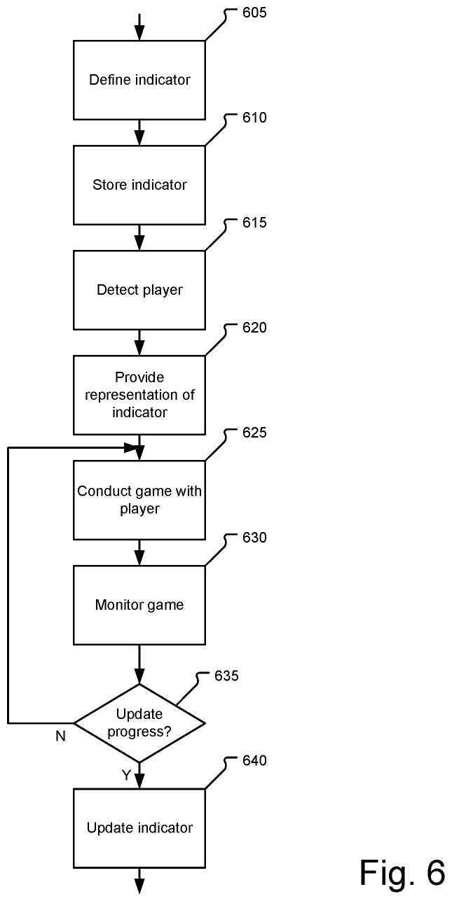

FIG. 6 is a flowchart illustrating an exemplary process for providing persistent indicators of personal progress in a gaming environment according to another embodiment of the present disclosure. As illustrated in this example, the process can begin with defining 605 and storing 610 an initial progress indicator for a player 120. In some cases, defining 605 an initial progress indicator can comprise receiving a selection of the from a host system 105 of a gaming venue. In other cases, defining 605 an initial progress indicator can comprise receiving from the player 120 a selection of the indicator from a plurality of available indicators of personal progress.

A presence of the player 120 of the electronic game can be detected 615 proximate to the gaming system 115. For example, the gaming system 115 can include a wireless communications interface and detecting 615 the player 120 of the electronic game can comprise detecting a mobile device 130 of the player 120 of the electronic game in proximity to the gaming system 115 through the wireless communications interface. In another example, detecting 615 the player 120 of the electronic game can comprise identifying the player 120 of the electronic game during initiation of the electronic game, e.g., during a card-in process.

In response to detecting 615 the player 120 of the electronic game, a representation of the indicator of personal progress for the player 120 of the electronic game can be provided 620 through the display device of the gaming system 115. In some cases, providing the representation of the indicator of personal progress for the player 120 of the electronic game can comprise displaying an animation of the indicator of personal progress for the player 120 of the electronic game.

The electronic game can be conducted 625 with the player 120 and game interaction information indicating an action of a player 120 of or occurrence of an event in the electronic game can be monitored 630 while conducting 625 the electronic game. A determination 635 can be made as to whether to update personal progress for the player 120 of the electronic game based on the game interaction information and one or more pre-defined criteria. In response to determining 635 to update the personal progress for the player 120 of the electronic game, the stored indicator of personal progress for a player 120 of an electronic game and the representation of the indicator of personal progress for a player 120 of an electronic game provided through the display device updated 640 based on the game interaction information.

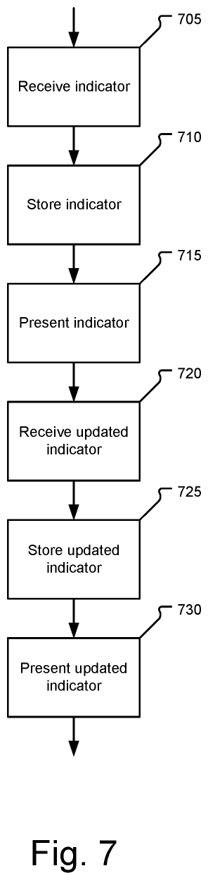

FIG. 7 is a flowchart illustrating an exemplary process for providing persistent indicators of personal progress in a gaming environment according to yet another embodiment of the present disclosure. As illustrated in this example, the process can begin with receiving 705 an indicator of personal progress in an electronic game for a user of the mobile device 130, storing 710 the indicator of the personal progress in the electronic game for the user of the mobile device 130, and presenting 715 the indicator of the personal progress in the electronic game for the user of the mobile device 130. For example, this initial indicator can be received when a player 120 first registers for personal progress indicators, initiates a game, enters a gaming venue, etc. Receiving 705 the indicator of personal progress in the electronic game for the user of the mobile device 130 can comprise receiving the indicator from a host system 105 of a gaming venue, from a gaming system 115 on which the electronic game is executed, or receiving a selection of one of a plurality of available indicators from a user of the mobile device 130. The indicator of the personal progress in the electronic game for the user of the mobile device 130 can comprise, for example, an animated graphic. As the player 120 plays an electronic game or otherwise interacts with the game and as determinations of progress are made by the gaming system 115 or host system 105 of the gaming venue, an updated indicator of personal progress in the electronic game for the user of the mobile device 130 and based on execution of the electronic game can be received 720 the updated indicator of the personal progress in the electronic game for the user of the mobile device 130 can be stored 725 and presented through the display of the mobile device 130.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player 120 to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player 120 before enabling that player 120 to place any wagers on any plays of any wagering games. In one example, the central server, central controller, or remote host identifies the player 120 by requiring a player 120 account of the player 120 to be logged into via an input of a unique player name and password combination assigned to the player 120. The central server, central controller, or remote host may, however, identify the player 120 in any other suitable manner, such as by validating a player tracking identification number associated with the player 120; by reading a player tracking card or other smart card inserted into a card reader; by validating a unique player identification number associated with the player 120 by the central server, central controller, or remote host; or by identifying the EGM (or personal gaming device), such as by identifying the MAC address or the IP address of the Internet facilitator. In various embodiments, once the central server, central controller, or remote host identifies the player 120, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Pat. No. 8,764,566, entitled “Internet Remote Game Server,” and U.S. Pat. No. 8,147,334, entitled “Universal Game Server.”

The central server, central controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A method for providing personal progress indicators in a gaming environment, the method comprising:
receiving, by a gaming venue host system, game interaction information related to an electronic game executed on a gaming system and indicating an action of a player of or occurrence of an event in the electronic game;
determining, by the gaming venue host system, whether the game interaction information is indicative of a change in personal progress for the player in the electronic game;
in response to determining the game interaction information is indicative of a change in personal process for the player in the electronic game, updating, by the gaming venue host system, an electronic record associated with the player of the electronic game to indicate the change in the personal progress for the player of the electronic game, and providing, by the gaming venue host system, an indication of the change in the personal progress for the player of the electronic game to the gaming system.

2. The method of claim 1, wherein the indication of the change in the personal progress for the player of the electronic game is based on a selection of an initial progress indicator received from the player of the electronic game and wherein the indication of the change provided to the gaming system comprises a visible change to the initial progress indicator.

3. The method of claim 1, wherein the indication of the change in the personal progress for the player of the electronic game is based on a selection of an initial progress indicator received from the gaming system and wherein the indication of the change provided to the gaming system comprises a change to the initial progress indicator.

4. The method of claim 1, wherein determining whether the game interaction information is indicative of a change in personal progress for a player of the electronic game is further based on one or more pre-defined criteria for activity occurring in the electronic game.

5. The method of claim 4, wherein updating the electronic record associated with the player of the electronic game to indicate the change in the personal progress for the player of the electronic game comprises updating the electronic record to indicate an improvement in the personal progress for the player of the electronic game when the game interaction information meets or exceeds one or more of the pre-defined criteria for activity occurring in the electronic game.

6. The method of claim 4, wherein updating the electronic record associated with the player of the electronic game to indicate the change in the personal progress for the player of the electronic game comprises updating the electronic record to indicate a decline in the personal progress for the player of the electronic game when the game interaction information does not meet one or more of the pre-defined criteria for activity occurring in the electronic game.

7. The method of claim 1, further comprising updating the electronic record to indicate a decline in the personal progress for the player of the electronic game if new game interaction information is not received from the gaming system within a predetermined period of time.

8. A gaming system comprising:
a display device;
a processor coupled with the display device; and
a memory coupled with and readable by the processor and storing therein a set of instructions which, when executed by the processor, causes the processor to:
store an indicator of personal progress for a player of an electronic game;
detect a presence of the player of the electronic game proximate to the gaming system; and
in response to detecting the player of the electronic game, provide, through the display device, a representation of the indicator of personal progress for the player of the electronic game.

9. The gaming system of claim 8, wherein providing, through the display device, the representation of the indicator of personal progress for the player of the electronic game comprises displaying an animation of the indicator of personal progress for the player of the electronic game.

10. The gaming system of claim 8, wherein the instructions further cause the processor to receive the indicator of personal progress for the player of the electronic game from a host system of a gaming venue.

11. The gaming system of claim 8 wherein the instructions further cause the processor to select the indicator of personal progress for the player of the electronic game from a plurality of available indicators of personal progress.

12. The gaming system of claim 8, wherein the instructions further cause the processor to:
conduct the electronic game with the player of the electronic game;
monitor game interaction information indicating an action of a player of or occurrence of an event in the electronic game while conducting the electronic game;
determine whether to update personal progress for the player of the electronic game based on the game interaction information and one or more pre-defined criteria; and
in response to determining to update the personal progress for the player of the electronic game, updating the stored indicator of personal progress for a player of an electronic game and the representation of the indicator of personal progress for a player of an electronic game provided through the display device based on the game interaction information.

13. The gaming system of claim 8, further comprising a wireless communications interface and wherein detecting the player of the electronic game comprises detecting a mobile device of the player of the electronic game in proximity to the gaming system through the wireless communications interface.

14. The gaming system of claim 8, wherein detecting the player of the electronic game comprises identifying the player of the electronic game during initiation of the electronic game.

15. A mobile device comprising:
a wireless communications interface;
a display device;
a processor coupled with the wireless communications interface and the display device; and
a memory coupled with and readable by the processor and storing therein a set of instructions which, when executed by the processor, causes the processor to:
receive, via the wireless communications interface, an indicator of personal progress in an electronic game for a user of the mobile device;
store, in the memory, the indicator of the personal progress in the electronic game for the user of the mobile device; and
present, through the display device, the indicator of the personal progress in the electronic game for the user of the mobile device.

16. The mobile device of claim 15, wherein receiving the indicator of personal progress in the electronic game for the user of the mobile device comprises receiving the indicator, through the wireless communication interface, from a host system of a gaming venue.

17. The mobile device of claim 15, wherein receiving the indicator of personal progress in the electronic game for the user of the mobile device comprises receiving the indicator, thought the wireless communication interface, from a gaming system on which the electronic game is executed.

18. The mobile device of claim 15, wherein receiving the indicator of personal progress in the electronic game for the user of the mobile device comprises receiving a selection of one of a plurality of available indicators from a user of the mobile device.

19. The mobile device of claim 15, wherein the indicator of the personal progress in the electronic game for the user of the mobile device comprises an animated graphic.

20. The mobile device of claim 15, wherein the instructions further cause the processor to:
receive, via the wireless communications interface, an updated indicator of personal progress in the electronic game for the user of the mobile device, wherein the updated indicator of personal progress is based on execution of the electronic game;
store, in the memory, the updated indicator of the personal progress in the electronic game for the user of the mobile device; and
present, through the display device, the updated indicator of the personal progress in the electronic game for the user of the mobile device.
